(19) United States
(12) Patent Application Publication
(10) Pub. No.: US 2026/0350838 A1
(43) Pub. Date: Nov. 5, 2026

(54) METHOD AND DEVICE FOR DETERMING LENS OCCLUSION REGION AND SEVERITY IN CAMERA

(71) Applicant: NEXTCHIP Co., Ltd., Seongnam-si (KR)

(72) Inventors: Sungjun LEE, Seongnam-si (KR); Jaeseok YOO, Seoul (KR); Soobeom LEE, Yongin-si (KR); Siho KIM, Seoul (KR)

(21) Appl. No.: 19/663,567

(22) Filed: Apr. 30, 2026

(30) Foreign Application Priority Data
May 2, 2025 (KR) 10-2025-0058236
Jun. 27, 2025 (KR) 10-2025-0086067

(51) Int. Cl. G06T 7/80; G06T 7/10

(52) U.S. Cl. CPC G06T 7/80; G06T 7/10; G06T 2207/20084; G06T 2207/30252

(57) ABSTRACT

A method performed by an electronic device includes obtaining a target image from a camera installed on a side of a vehicle, segmenting the target image into a plurality of cells by applying a plurality of grids that is preset to the target image, determining a first occlusion ratio with respect to a first cell of the plurality of cells using a first model that is pre-trained, determining an occlusion ratio with respect to the target image based on the first occlusion ratio, and controlling the electronic device based on the occlusion ratio.

### CROSS-REFERENCE TO RELATED APPLICATIONS

This application claims the benefit of Korean Patent Application No. 10-2025-0058236, filed on May 2, 2025, and Korean Patent Application No. 10-2025-0086067, filed on Jun. 27, 2025, in the Korean Intellectual Property Office (now the Ministry of Intellectual Property (MOIP)), the entire disclosures of which are incorporated herein by reference for all purposes.

### BACKGROUND

### 1. Field of the Invention

The embodiments relate to a method of determining a lens occlusion region and severity of a camera, and more particularly, to a method of determining an occlusion region and severity by segmenting an image captured by a camera into a plurality of cells and predicting whether each cell is occluded using an artificial intelligence model.

### 2. Description of the Related Art

An autonomous vehicle or a vehicle that supports an advanced driver assistance system (ADAS) may recognize a situation around the vehicle using one or more sensors and may control the vehicle based on the recognized situation. For example, a vehicle, a pedestrian, and a lane may be detected using an image obtained by a camera, and a driving path may be determined. A control command, such as braking, steering, and warning, may be performed according to the position or movement of a recognized object.

### SUMMARY

An embodiment may control an electronic device based on an occlusion ratio of a target image.

An embodiment may be an electronic device for controlling an electronic device based on an occlusion ratio of a target image.

However, the technical goals are not limited to those described above, and other technical goals may be present.

According to an embodiment, a method performed by an electronic device includes obtaining a target image from a camera installed on a side of a vehicle, segmenting the target image into a plurality of cells by applying a plurality of grids that is preset to the target image, determining a first occlusion ratio with respect to a first cell of the plurality of cells using a first model that is pre-trained, determining an occlusion ratio with respect to the target image based on the first occlusion ratio, and controlling the electronic device based on the occlusion ratio.

The determining of the occlusion ratio with respect to the target image based on the first occlusion ratio includes determining the occlusion ratio, based on the first occlusion ratio and a second occlusion ratio with respect to a second cell of the plurality of cells.

The determining of the occlusion ratio, based on the first occlusion ratio and the second occlusion ratio, includes determining a mean of the first occlusion ratio and the second occlusion ratio to be the occlusion ratio.

The method further includes determining severity of contamination with respect to the target image to be one of a plurality of grades based on the occlusion ratio.

The method further includes determining an occlusion value with respect to each pixel of the target image using a second model that is pre-trained, and determining a first corrected occlusion ratio, based on the first occlusion ratio and occlusion ratios with respect to first pixels included in the first cell.

The method further includes determining a first block including one or more cells, wherein the first block includes a first cell, determining whether the first occlusion ratio is greater than or equal to a preset ratio, and determining whether occlusion is present in the first block based on whether the first occlusion ratio is greater than or equal to the preset ratio.

The method further includes, when the occlusion is determined to be present in the first block, outputting position information about the first block.

The determining of the occlusion ratio, based on the first occlusion ratio and the second occlusion ratio, includes determining a first weight with respect to the first cell, determining a first value, based on the first occlusion ratio and the first weight, determining a second weight with respect to the second cell, determining a second value, based on the second occlusion ratio and the second weight, and determining the occlusion ratio, based on the first value and the second value.

The controlling of the electronic device based on the occlusion ratio includes, when the occlusion ratio is greater than or equal to a preset value, controlling the electronic device to output a notification.

The controlling of the electronic device based on the occlusion ratio includes, when the occlusion ratio is greater than or equal to a preset value, generating a message instructing not to use the target image for controlling the vehicle, and transmitting the message to an external electronic device that controls the vehicle.

According to an embodiment, a non-transitory computer-readable storage medium storing instructions performs the method.

According to an embodiment, an electronic device includes at least one processor including processing circuitry, and memory including one or more storage media storing instructions, wherein the instructions, when executed individually or collectively by the at least one processor, cause the electronic device to perform obtaining a target image from a camera installed on a side of a vehicle, segmenting the target image into a plurality of cells by applying a plurality of grids that is preset to the target image, determining a first occlusion ratio with respect to a first cell of the plurality of cells using a first model that is pre-trained, determining an occlusion ratio with respect to the target image based on the first occlusion ratio, and controlling the electronic device based on the occlusion ratio.

The determining of the occlusion ratio with respect to the target image based on the first occlusion ratio includes determining the occlusion ratio, based on the first occlusion ratio and a second occlusion ratio with respect to a second cell of the plurality of cells.

The instructions, when executed individually or collectively by the at least one processor, cause the electronic device to further perform determining an occlusion value with respect to each pixel of the target image using a second model that is pre-trained, and determining a first corrected occlusion ratio, based on the first occlusion ratio and occlusion ratios with respect to first pixels included in the first cell.

The instructions, when executed individually or collectively by the at least one processor, cause the electronic device to further perform determining a first block including one or more cells, wherein the first block includes a first cell, determining whether the first occlusion ratio is greater than or equal to a preset ratio, and determining whether occlusion is present in the first block based on whether the first occlusion ratio is greater than or equal to the preset ratio.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an image of which a portion is occluded by contamination according to an embodiment;

FIG. 2 illustrates a configuration of an electronic device that determines an occlusion ratio and controls an electronic device based on the occlusion ratio according to an embodiment;

FIG. 3 is a flowchart of a method of controlling an electronic device based on an occlusion ratio with respect to a target image according to an embodiment;

FIG. 4 is a flowchart of a method of determining a first corrected occlusion ratio, based on a first occlusion ratio and occlusion values with respect to first pixels included in a first cell according to an embodiment;

FIG. 5 illustrates a first occlusion ratio, occlusion values with respect to first pixels, and a first corrected occlusion ratio according to an embodiment;

FIG. 6 is a flowchart of a method of outputting position information in which occlusion is present according to an embodiment;

FIG. 7 is a flowchart of a method of determining whether occlusion is present in a first block and outputting position information according to an embodiment;

FIG. 8 illustrates a first block with occlusion and a second block without occlusion according to an embodiment;

FIG. 9 is a flowchart of a method of determining an occlusion ratio with respect to a target image according to an embodiment;

FIG. 10 is a flowchart of a method of determining an occlusion ratio with respect to a target image according to a weight according to an embodiment;

FIG. 11 is a flowchart of a method of controlling an electronic device based on an occlusion ratio according to an embodiment; and

FIG. 12 is a flowchart of a method of learning an occlusion ratio with respect to a target image according to an embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

Terms, such as “first”, “second”, and the like may be used herein to describe components. Each of these terminologies is not used to define an essence, order or sequence of a corresponding component but used merely to distinguish the corresponding component from other component(s). For example, a first component may be referred to as a second component, or similarly, the second component may be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

As used herein, the singular form is intended to include the plural forms as well, unless the context clearly indicates otherwise. It will be understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto is omitted.

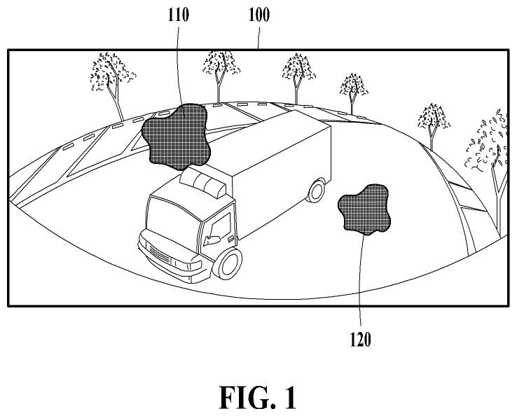

FIG. 1 illustrates an image in which a portion of a target image is occluded by contamination according to an embodiment.

According to an embodiment, a vehicle may include a camera. The camera may be installed on a side, such as a front surface, a rear surface, a left surface, or a right surface of the vehicle. However, the embodiment is not limited thereto. For example, the camera may be installed to capture the front of the vehicle, and the camera may obtain an image 100 by capturing the front of the vehicle. For example, the camera may generate a video by capturing consecutive images, and an image may be a frame of the video.

According to an embodiment, the camera may be a monocular camera. For example, the camera may include a pinhole lens or a fisheye lens, but is not limited thereto. The image 100 obtained by the camera may be converted into a digital image, and the digital image may be a red, green, blue (RGB) image or a grayscale image.

According to an embodiment, when the camera lens is contaminated, one or more contaminated regions 110 and 120 may be generated in a portion of the image 100 obtained by the camera. For example, the contaminated regions 110 and 120 of the image 100 may be generated as a foreign substance, such as dust or a stain attached to the surface of the lens of the camera, or a scratch on the lens occludes a portion or the entirety of the camera lens. The contaminated regions 110 and 120 may cause a malfunction in a perception system of the vehicle operating based on the image 100. For example, in a perception system based on an image, such as an advanced driver assistance system (ADAS) or an intelligent surveillance system, the performance and reliability of the system may be affected by whether the camera lens is occluded. The contaminated regions 110 and 120 may occupy an area less than or equal to 5% of the entire area of the image 100; however, the example is not limited thereto. One or more contaminated regions 110 and 120 may be present in one image 100. The contaminated regions 110 and 120 may be formed at any position in the image 100.

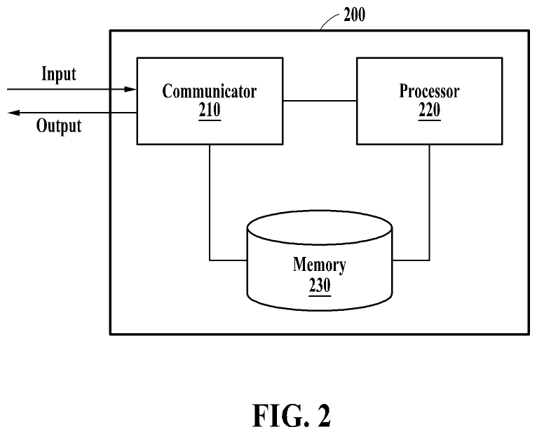

FIG. 2 illustrates a configuration of an electronic device that determines an occlusion ratio and controls an electronic device based on the occlusion ratio according to an embodiment.

According to an embodiment, an electronic device 200 may include a communicator 210, a processor 220, and a memory 230. In an embodiment, at least one of the components described above may be omitted from the electronic device 200, or one or more other components may be added to the electronic device 200. In addition, the electronic device 200 may further include a camera and a display.

The communicator 210 may be connected to the processor 220, the memory 230, other components of the electronic device 200, and/or an external electronic device to transmit and receive data therebetween. Hereinafter, the expression “transmitting and receiving A” may be construed as transmitting and receiving “information or data indicating A.”

The communicator 210 may be implemented as circuitry in the electronic device 200. For example, the communicator 210 may include an internal bus and an external bus. According to an embodiment, the communicator 210 may include a wireless communication module (e.g., a cellular communication module, a short-range wireless communication module, or a global navigation satellite system (GNSS) communication module) and/or a wired communication module. A corresponding one of these communication modules may communicate with other components of the electronic device 200 and/or the external electronic device via a short-range communication network, such as Bluetooth™, wireless-fidelity (Wi-Fi), or infrared data association (IrDA)), or a long-range communication network, such as a legacy cellular network, a 5G network, a next-generation communication network, the Internet, or a computer network (e.g., a local area network (LAN) or a wide area network (WAN)).

The processor 220 may process data received by the communicator 210 and data stored in the memory 230. The “processor” may be a hardware-implemented data processing device that has a circuit that is physically structured to execute desired operations. The desired operations may include, for example, code or instructions included in a program. For example, the hardware-implemented data processing device may include a microprocessor, a central processing unit (CPU), a processor core, a multi-core processor, a multiprocessor, an application-specific integrated circuit (ASIC), and a field-programmable gate array (FPGA). The processor 220 may execute computer-readable code (e.g., software) stored in the memory 230 and instructions triggered by the processor 220.

The memory 230 may store data received by the communicator 210 and data processed by the processor 220. For example, the memory 230 may store the program (or an application, or software). The program to be stored may be a set of syntax that is coded and executable by the processor 220 to control the electronic device 200. According to an embodiment, the memory 230 may include at least one volatile memory, non-volatile memory, random-access memory (RAM), flash memory, a hard disk drive, and an optical disk drive. The memory 230 may store an instruction set (e.g., software) for operating the electronic device 200. The instruction set for operating the electronic device 200 may be executed by the processor 220.

The electronic device 200 may include a control module therein. The control module may control an internal component of the electronic device 200 to control an operation of the electronic device 200. The communicator 210 of the electronic device 200 may be connected to an external electronic device to transmit a control command to operate the external electronic device. For example, the external electronic device may include an electronic control unit (ECU) for a vehicle.

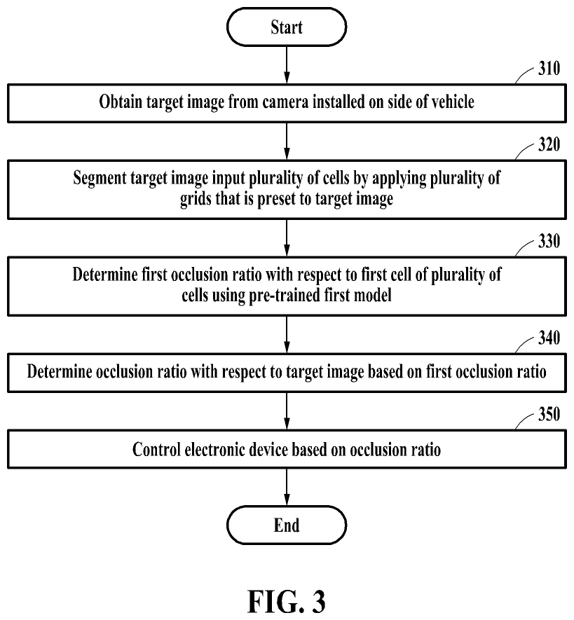

FIG. 3 is a flowchart of a method of controlling an electronic device based on an occlusion ratio with respect to a target image according to an embodiment.

According to an embodiment, operations 310 to 350 described with reference to FIG. 3 may be performed by the electronic device 200 described above with reference to FIG. 2. For example, the electronic device 200 may configure an ADAS system. For example, the electronic device 200 may be a part of the ADAS system. The ADAS system may include an ECU for controlling the vehicle.

In operation 310, the electronic device 200 may obtain a target image from a camera installed on a side of the vehicle. For example, a front image (e.g., the image 100 of FIG. 1) may be obtained from a camera installed on the vehicle to capture the front of the vehicle. For example, when the camera lens is contaminated, one or more contaminated regions (e.g., the contaminated regions 110 and 120 of FIG. 1) may be included in a portion of the image obtained from the camera. The target image may include an image (e.g., the image 100 of FIG. 1) that is directly obtained from the camera or an image obtained by preprocessing the obtained image (e.g., resolution adjustment or contrast adjustment).

In operation 320, the electronic device 200 may segment the target image into a plurality of cells by applying a plurality of grids that is preset to the target image. For example, the plurality of grids may be set by dividing the entire region of the target image into equal intervals based on horizontal and vertical directions. The grid may be set at variable intervals. The plurality of grids may indicate a segmentation reference with respect to the target image, and the cell may indicate an actual segmentation result (in other words, a partial image) of the target image generated along the grid. According to an embodiment, the electronic device 200 may set N horizontal reference lines and M vertical reference lines to the entire region of the target image. The grid structure formed by a combination of the horizontal and vertical reference lines may be defined as a grid, and each region of the target image segmented by the grid may be defined as a cell.

In operation 330, the electronic device 200 may determine a first occlusion ratio with respect to a first cell of the plurality of cells using a first model that is pre-trained (or trained). The first occlusion ratio may represent a ratio of an area occupied by a contaminated region in the first cell to the first cell area. The pre-trained first model may be an artificial intelligence (AI)-based model that is trained to predict each occlusion ratio of the plurality of cells of the target image. For example, the first model may be a model trained using multiple training images and ground truth labels (e.g., a cell-level occlusion ratio). The first model may be configured based on a deep learning architecture, such as a convolutional neural network (CNN). However, the embodiment is not limited thereto. The first model may output the occlusion ratio with respect to each cell by receiving the target image.

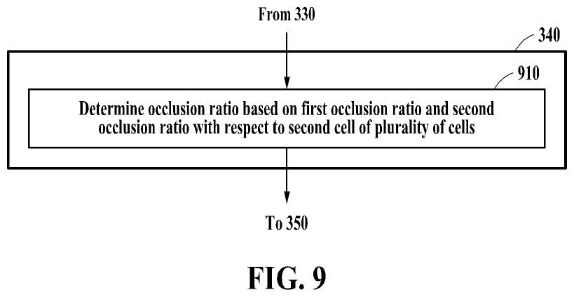

In operation 340, the electronic device 200 may determine an occlusion ratio with respect to the target image based on the first occlusion ratio with respect to the first cell. For example, the occlusion ratio with respect to the target image may be a mean of occlusion ratios of the plurality of cells. According to an embodiment, the electronic device 200 may determine the severity of contamination with respect to the target image to be one of grades based on the occlusion ratio. According to an embodiment, the severity of contamination may be classified into 10 grades from grade 0 to grade 9 according to a range of the occlusion ratio with respect to the entire target image. For example, when the occlusion ratio is greater than or equal to 0 and less than 10%, the severity of contamination may be determined to be grade 0. For example, when the occlusion ratio is greater than or equal to 90% and less than or equal to 100%, the severity of contamination may be determined to be grade 9. A method of determining the occlusion ratio with respect to the target image is further described with reference to FIG. 9 below.

In operation 350, the electronic device 200 may control an electronic device based on the occlusion ratio. The target controlled by the electronic device 200 may be an internal module of the electronic device 200 or an external electronic device.

According to an embodiment, when the occlusion ratio is greater than or equal to a preset value, the electronic device 200 may control the electronic device to output a notification. For example, when the occlusion ratio is greater than or equal to the preset value (e.g., 70%), a notification that cleaning or inspecting the lens is required may be output to a driver via means, such as a display, warning light, or a voice announcement. According to an embodiment, the electronic device 200 may control the electronic device to output a notification that has a different warning intensity or scheme according to the severity of contamination. For example, when the severity of contamination is low (e.g., less than or equal to grade 3), only a visual notification message may be displayed on the display in the vehicle. For example, when the severity of contamination is high (e.g., greater than or equal to grade 7), a visual notification message, warning light, and a voice announcement may be additionally output.

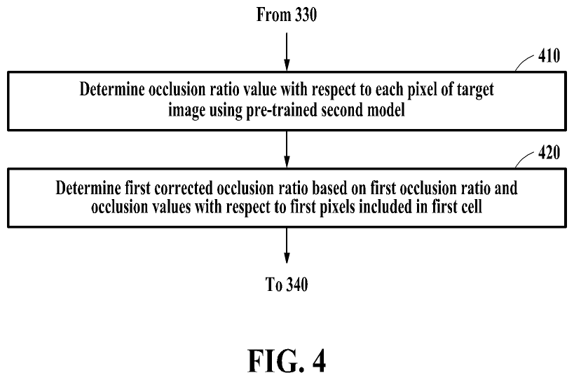

FIG. 4 is a flowchart of a method of determining a first corrected occlusion ratio, based on a first occlusion ratio and occlusion values with respect to first pixels included in a first cell according to an embodiment.

According to an embodiment, operations 410 and 420 may be performed after operation 330 described above with reference to FIG. 3. According to an embodiment, operations 410 and 420 may be performed by the electronic device 200 described above with reference to FIG. 2.

In operation 410, the electronic device 200 may determine an occlusion value with respect to each pixel of the target image using a second model that is pre-trained. According to an embodiment, the first model and the second model may be independent AI models. For example, the first model may be a regression or classification-based model for predicting an occlusion ratio of each pixel by receiving the target image. For example, the second model may be a segmentation model that is separately configured and may be used to determine an occlusion value (or level) of each pixel of the target image. For example, when a pixel is occluded, the occlusion value of the pixel may be set to 1, and when the pixel is not occluded, the occlusion value of the pixel may be set to 0.

According to an embodiment, in the electronic device 200, the pre-trained first model and the pre-trained second model may be implemented as the same AI model. For example, a pre-trained model may receive the target image and may determine an occlusion ratio (e.g., a first output) with respect to each cell and an occlusion value (e.g., a second output) of each pixel. The pre-trained model may be based on a common feature extraction layer, but an output layer may be divided into a plurality of paths responsible for cell-wise regression or classification, and pixel-wise segmentation.

In operation 420, the electronic device 200 may determine a first corrected occlusion ratio, based on a first occlusion ratio with respect to a first cell and occlusion values with respect to first pixels included in the first cell. For example, the pre-trained first model may determine that the first occlusion ratio with respect to the first cell is 80%. For example, when the number of first pixels included in the first cell is 100 and the pre-trained second model determines that 60 of the 100 pixels are occluded, an occlusion value for each of the 60 pixels of the first pixels may be set to 1 and an occlusion value for each of the remaining 40 pixels of the first pixels may be set to 0.

According to an embodiment, the electronic device 200 may calculate a first corrected occlusion ratio based on a weighted sum of the first occlusion ratio and a mean occlusion value of the first pixels. For example, when the number of first pixels included in the first cell is 100, and for the occlusion values with respect to the first pixels, the occlusion values are set to 1 for 60 pixels and set to 0 for the remaining 40 pixels, a mean occlusion value of the first pixels may be 0.6. For example, when the first occlusion ratio with respect to the first pixel is 0.8, the mean occlusion value of the first pixels included in the first cell is 0.6, and a weight assigned to the first occlusion ratio is 0.9, the first corrected occlusion ratio may be represented as Equation 1 below.

Corrected occlusion ratio=(0.8×0.9)+(0.6×0.1)=0.72+0.06=0.78 [Equation 1]

According to an embodiment, the electronic device 200 may determine the first corrected occlusion ratio by combining the first occlusion ratio with the mean occlusion value of the first pixels in a non-linear manner. For example, the two values may be combined using a root mean square to calculate the first corrected occlusion ratio.

A detailed occlusion distribution in the first cell may be accurately represented by correcting the first occlusion ratio based on the occlusion values of the first pixels.

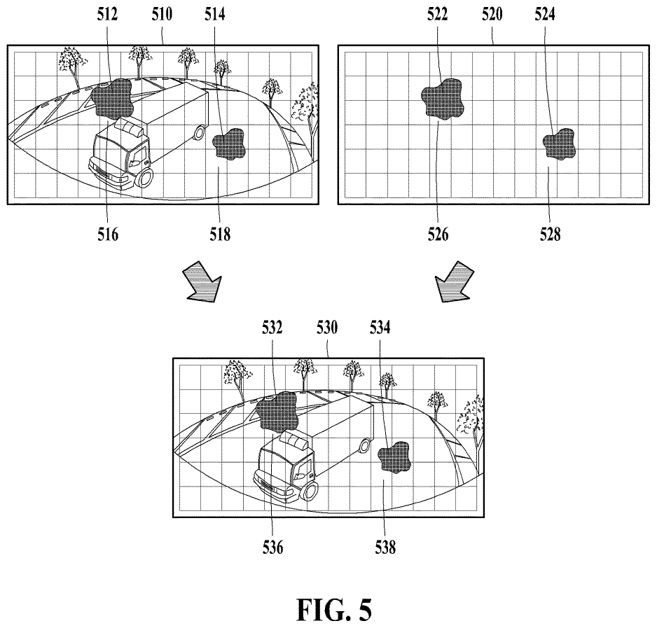

FIG. 5 illustrates a first occlusion ratio, occlusion values with respect to first pixels, and a first corrected occlusion ratio according to an embodiment.

According to an embodiment, in a target image 510, a portion of the target image 510 may be occluded by one or more contaminated regions (e.g., a first contaminated region 512 or a second contaminated region 514). The second contaminated region 514 may have a feature that is the same as or different from the first contaminated region 512 in terms of shape, position, or cause of occurrence. For example, the first contaminated region 512 may be caused by a dust particle, and the second contaminated region 514 may be caused by a water droplet. The target image 510 may be segmented into a plurality of cells based on a plurality of grids that is preset. One or more contaminated regions may be disposed across some of the plurality of cells, and a region of some cells may be partially or wholly occluded by one or more contaminated regions. The electronic device 200 may determine a first occlusion ratio and/or a second occlusion ratio with respect to the target image 510 using a first model that is pre-trained. The first occlusion ratio may represent a ratio (e.g., 0.8) of the area size occupied by a contaminated region in a first cell 516 compared to the area size of the first cell 516. The second occlusion ratio may represent a ratio (e.g., 0.2) of the area size occupied by a contaminated region in a second cell 518 compared to the second cell 518.

According to an embodiment, the electronic device 200 may generate a mask image 520 corresponding to the target image 510 using a second model that is pre-trained. The mask image 520 may include an occlusion value of each pixel. The occlusion value of each pixel may be set to 1 when the pixel is occluded, and may be set to 0 when the pixel is not occluded. For example, an occlusion value of each pixel included in a first contaminated mask region 522 of the mask image 520 corresponding to the first contaminated region 512 of the target image 510 may be set to 1. For example, an occlusion value of each pixel included in a second contaminated mask region 524 of the mask image 520 corresponding to the second contaminated region 514 of the target image 510 may be set to 1. An occlusion value of each pixel included in the remaining region other than the first contaminated mask region 522 or the second contaminated mask region 524 in the mask image 520 may be set to 0. The first cell 516 of the target image 510 may correspond to a first cell 526 of the mask image 520, and the second cell 518 of the target image 510 may correspond to a second cell 528 of the mask image 520. For example, when the number of first pixels included in the first cell 526 is 100, occlusion values with respect to 80 pixels are set to 1, and occlusion values with respect to the remaining 20 pixels are set to 0, a mean occlusion value of the first pixels may be 0.8. For example, when the number of second pixels included in the second cell 528 is 100, occlusion values with respect to 20 pixels are set to 1, and occlusion values with respect to the remaining 80 pixels are set to 0, a mean occlusion value of the second pixels may be 0.2.

According to an embodiment, the electronic device 200 may generate a corrected image 530 by correcting the target image 510 based on the occlusion values included in the mask image 520. A first corrected contaminated region 532 and a second corrected contaminated region 534 included in the corrected image 530 may correspond to the first contaminated region 512 and the second contaminated region 514 included in the target image 510, respectively. The first cell 516 of the target image 510 may correspond to a first cell 536 of the corrected image 530, and the second cell 518 of the target image 510 may correspond to a second cell 538 of the corrected image 530.

A first corrected occlusion ratio with respect to the first cell 536 of the corrected image 530 may be determined based on the first occlusion ratio of the first cell 516 in the target image 510 and occlusion values with respect to first pixels included in the first cell 526 in the mask image 520. For example, when the first occlusion ratio of the first cell 516 in the target image 510 is determined to be 0.8 by the pre-trained first model and a mean of occlusion values with respect to the first pixels included in the first cell 526 in the mask image 520 is determined to be 0.6 by the pre-trained second model, if a weight assigned to the first occlusion ratio is 0.9, the first corrected occlusion ratio with respect to the first cell 536 of the corrected image 530 may be calculated to be 0.78.

A second corrected occlusion ratio with respect to the second cell 538 of the corrected image 530 may be determined based on a second occlusion ratio of the second cell 518 in the target image 510 and occlusion values with respect to second pixels included in the second cell 528 in the mask image 520. For example, when the second occlusion ratio of the second cell 518 in the target image 510 is determined to be 0.5 by the pre-trained first model and a mean of occlusion values with respect to the second pixels included in the second cell 528 in the mask image 520 is determined to be 0.6 by the pre-trained second model, if a weight assigned to the second occlusion ratio is 0.9, the second corrected occlusion ratio with respect to the second cell 538 of the corrected image 530 may be calculated to be 0.51.

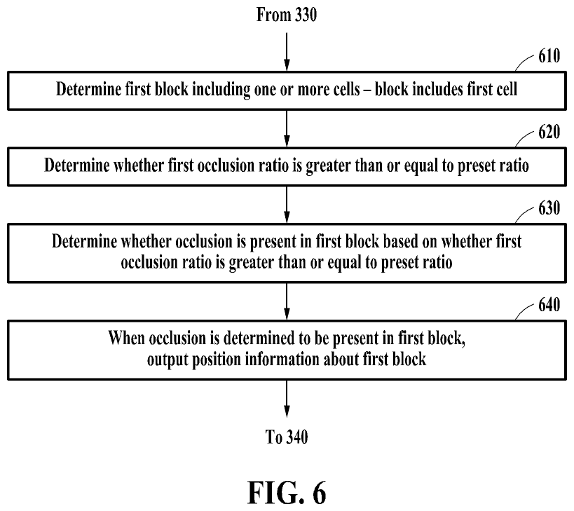

FIG. 6 is a flowchart of a method of outputting position information in which occlusion is present according to an embodiment.

According to an embodiment, operations 610 to 640 may be performed after operation 330 described above with reference to FIG. 3. According to an embodiment, operations 610 to 640 may be performed by the electronic device 200 described above with reference to FIG. 2.

In operation 610, the electronic device 200 may determine a first block including one or more of a plurality of cells of a target image. The first block may include a first cell. For example, the first block may be formed as a set of consecutive cells forming a portion of the target image.

In operation 620, the electronic device 200 may determine whether a first occlusion ratio with respect to the first cell is greater than or equal to a preset ratio (or value) (e.g., 0.7). The first occlusion ratio may be substituted with the first corrected occlusion ratio described with reference to FIG. 4. When the first block includes a plurality of cells, whether an occlusion ratio with respect to each cell is greater than or equal to the preset value may be determined. Among the plurality of cells, the number of cells that have the occlusion ratio greater than or equal to the preset value may be counted.

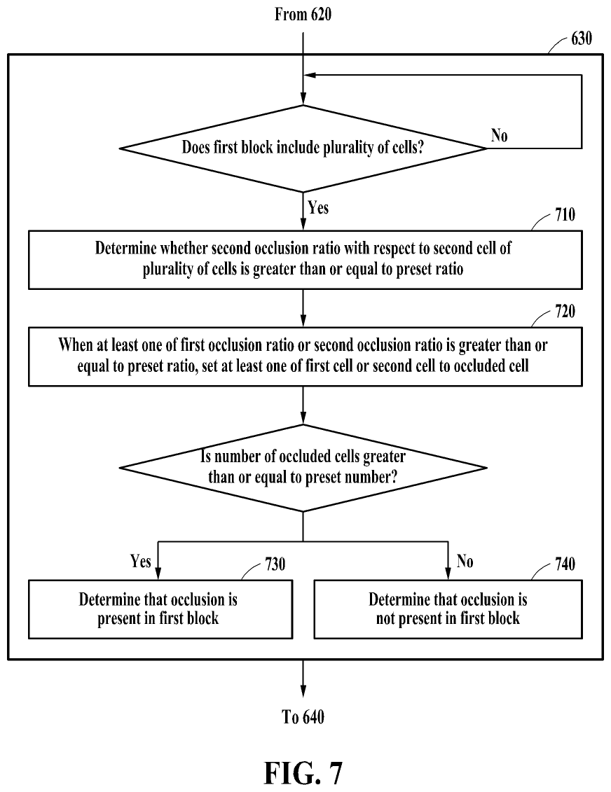

In operation 630, the electronic device 200 may determine whether occlusion is present in the first block based on whether the first occlusion ratio is greater than or equal to the preset ratio (or value). For example, when the number of cells counted with respect to the first block is greater than or equal to a preset threshold, the occlusion is determined to be present in the first block. The method of determining whether occlusion is present in the first block is further described below with reference to FIG. 7.

In operation 640, when the occlusion is determined to be present in the first block, the electronic device 200 may output position information about the first block. For example, the electronic device 200 may output a region corresponding to the position of the first block in the target image using a visual representation, such as an edge box or an icon. According to an embodiment, the electronic device 200 may perform contamination correction or removal processing by providing the position information about the first block to a subsequent processing module as an input value.

FIG. 7 is a flowchart of a method of determining whether occlusion is present in a first block and outputting position information according to an embodiment.

According to an embodiment, operations 710 to 740 may be performed after operation 620 described above with reference to FIG. 6. For example, operation 630 described above with reference to FIG. 6 may include operations 710 to 740. For example, operations 710 to 740 may be performed before operation 640 described above is performed. According to an embodiment, operations 710 to 740 may be performed by the electronic device 200 described above with reference to FIG. 2.

In operation 710, when a first block includes a plurality of cells, the electronic device 200 may determine whether a second occlusion ratio with respect to a second cell of the plurality of cells is greater than or equal to a preset ratio (or value). The second occlusion ratio may be substituted with the second corrected occlusion ratio described above with reference to FIG. 5. According to an embodiment, when the first block includes the plurality of cells, an electronic device 200 may determine whether an occlusion ratio with respect to each of the plurality of cells is greater than or equal to a preset ratio (or value).

When the first block includes only a first cell as a single cell, the electronic device 200 may determine whether occlusion is present in the first block based on whether a first occlusion ratio with respect to the first cell is greater than or equal to the preset ratio.

In operation 720, when at least one of the first occlusion ratio or the second occlusion ratio is greater than or equal to the preset ratio, the electronic device 200 may set (or determine) that at least one of the first cell and the second cell is an occluded cell. For example, when the first occlusion ratio corresponding to the first cell is 60%, the second occlusion ratio corresponding to the second cell is 80%, and the preset ratio is 70%, the second cell may be set to an occluded cell.

In operation 730, when the number of cells determined to be occluded is greater than a preset number among the plurality of cells included in the first block, the electronic device 200 may determine that the occlusion is present in the first block. For example, when the preset number is 2, the first occlusion ratio corresponding to the first cell is 90%, the second occlusion ratio corresponding to the second cell is 80%, and the preset ratio is 70%, the first cell and the second cell may be determined to be occluded cells, and since the number of occluded cells is greater than the preset number, the occlusion may be determined to be present in the first block.

In operation 740, when the number of occluded cells is less than the preset number, the electronic device 200 may determine that the occlusion is not present in the first block. For example, when the preset number is 2, the first occlusion ratio corresponding to the first cell is 60%, the second occlusion ratio corresponding to the second cell is 80%, and the preset ratio is 70%, only the second cell may be determined to be occluded, and since the number of occluded cells is less than the preset number, the occlusion may be determined not to be present in the first block.

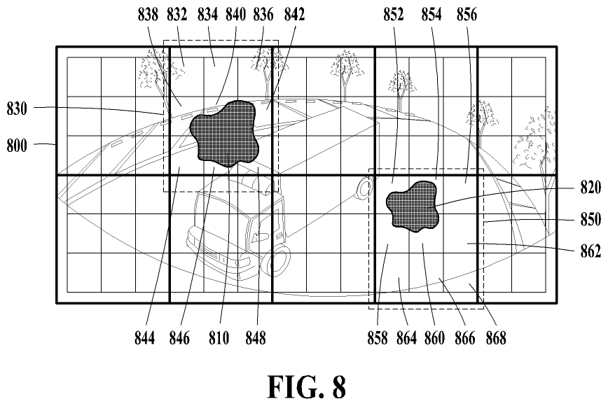

FIG. 8 illustrates a first block with occlusion and a second block without occlusion according to an embodiment.

A target image 800 may correspond to the target image 510 of FIG. 5 or the corrected image 530 of FIG. 5. The target image 800 may include one or more contaminated regions (e.g., the first contaminated region 810 or the second contaminated region 820). The target image 800 may be segmented into one or more blocks (e.g., a first block 830 or a second block 850). A block may include one or more cells. For example, the first block 830 may include a first cell 832, a second cell 834, a third cell 836, a fourth cell 838, a fifth cell 840, a sixth cell 842, a seventh cell 844, an eighth cell 846, and a ninth cell 848. For example, the second block 850 may include a first cell 852, a second cell 854, a third cell 856, a fourth cell 858, a fifth cell 860, a sixth cell 862, a seventh cell 864, an eighth cell 866, and a ninth cell 868.

Since the first block 830 includes a plurality of cells, whether an occlusion ratio with respect to each of the plurality of cells of the first block 830 is greater than or equal to a preset ratio (or value) may be determined. For example, when the preset ratio is 0.7, the electronic device 200 described above with reference to FIG. 2 may determine whether occlusion ratios with respect to the first cell 832 to the ninth cell 848 are greater than or equal to 0.7, respectively. As illustrated in FIG. 8, although at least partial occlusion is present in each of the fourth cell 834 to the ninth cell 848, the fifth cell 840 and the eighth cell 846 that have the occlusion ratios greater than or equal to 0.7 as the preset ratio may be determined to be occluded cells. The fifth cell 840 and the eighth cell 846 may be set to occluded cells. When the number of occluded cells with respect to the first block 830 is greater than or equal to a preset number, occlusion may be determined to be present in the first block 830. For example, when the preset number is 2, since the number of occluded cells (in other words, the fifth cell 840 and the eighth cell 846) with respect to the first block 830 is greater than or equal to the preset number, the occlusion may be determined to be present in the first block 830.

Since the second block 850 includes a plurality of cells, whether an occlusion ratio with respect to each of the plurality of cells of the second block 850 is greater than or equal to the preset ratio (or value) may be determined. For example, when the preset ratio is 0.7, the electronic device 200 may determine whether occlusion ratios with respect to the first cell 852 to the ninth cell 878 are greater than or equal to 0.7, respectively. As illustrated in FIG. 8, although at least partial occlusion is present in each of the first cell 852, the second cell 854, the fourth cell 852, and the fifth cell 860, only the second cell 854 that have the occlusion ratio greater than or equal to 0.7 as the preset ratio may be determined to be an occluded cell. The second cell 854 may be set to an occluded cell. When the number of occluded cells with respect to the second block 850 is greater than or equal to a preset number, occlusion may be determined to be present in the second block 850. For example, when the preset number is 2, since the number of occluded cells (in other words, the second cell 854) with respect to the second block 850 is less than the preset number, the occlusion may be determined not to be present in the second block 850.

FIG. 9 is a flowchart of a method of determining an occlusion ratio with respect to a target image according to an embodiment.

According to an embodiment, operation 910 may be performed after operation 330 described above with reference to FIG. 3. For example, operation 340 described above with reference to FIG. 3 may include operation 910. For example, operation 910 may be performed before operation 350 described above is performed. According to an embodiment, operation 910 may be performed by the electronic device 200 described above with reference to FIG. 2.

In operation 910, the electronic device 200 may determine occlusion ratios with respect to a plurality of cells based on a first occlusion ratio with respect to a first cell and a second occlusion ratio with respect to a second cell among a plurality of cells of a target image. For example, the second occlusion ratio may be determined in the same manner as the first occlusion ratio by inputting the target image into a pre-trained first model. The second occlusion ratio may be determined in a different manner from the first occlusion ratio, and for example, may be determined based on accumulated contamination information on a plurality of consecutive frames. According to an embodiment, the electronic device 200 may determine a mean of the first occlusion ratio and the second occlusion ratio to be the occlusion ratio with respect to the plurality of cells. The first occlusion ratio may be substituted with the first corrected occlusion ratio described with reference to FIG. 4. According to an embodiment, the electronic device 200 may display the occlusion ratio at the upper part of the target image.

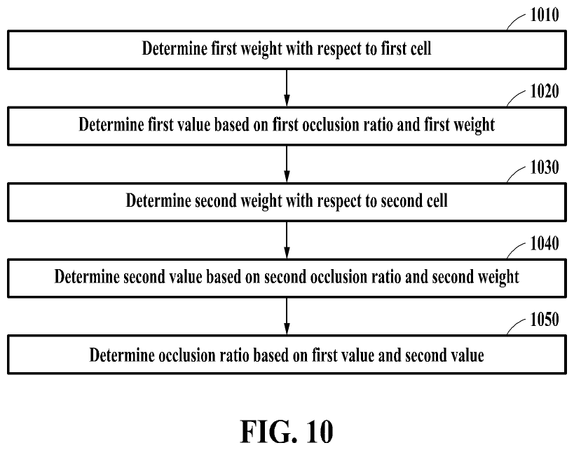

FIG. 10 is a flowchart of a method of determining an occlusion ratio with respect to a target image according to a weight according to an embodiment.

According to an embodiment, operation 910 described above with reference to FIG. 9 may include operations 1010 to 1050. According to an embodiment, operations 1010 to 1050 may be performed by the electronic device 200 described above with reference to FIG. 2.

In operation 1010, the electronic device 200 may determine a first weight with respect to a first cell of a plurality of cells of a target image. According to an embodiment, the electronic device 200 may determine the first weight based on a position of the first cell. For example, as the first cell is positioned closer to the center of the target image, the first weight may increase. For example, when the first cell is positioned at the top left and does not significantly obstruct the field of vision of a driver, the first weight may be determined to be low.

In operation 1020, the electronic device 200 may determine a first value, based on a first occlusion ratio and the first weight. The first occlusion ratio may be substituted with the first corrected occlusion ratio described with reference to FIG. 4. The first value may be calculated to be the result of a multiplication operation of the first occlusion ratio and the first weight.

In operation 1030, the electronic device 200 may determine a second weight with respect to a second cell of the plurality of cells of the target image. According to an embodiment, the electronic device 200 may determine the second weight based on a position of the second cell. According to an embodiment, the electronic device 200 may determine the second weight based on the importance of an object included in the second cell. For example, when an object with high priority, such as a human, is included in the second cell, the second weight may be set to be high.

In operation 1040, the electronic device 200 may determine a second value, based on a second occlusion ratio and the second weight. The second occlusion ratio may be substituted with the second corrected occlusion ratio described above with reference to FIG. 5.

In operation 1050, the electronic device 200 may determine an occlusion ratio with respect to the target image, based on the first value and the second value. According to an embodiment, the electronic device 200 may determine a mean of the first value and the second value to be the occlusion ratio. According to an embodiment, the electronic device 200 may determine occlusion ratios and weights with respect to the plurality of cells, respectively, and may determine, to be the occlusion ratio, a value obtained by dividing the sum of the products of occlusion ratios of the cells and the weight by the sum of the total weights.

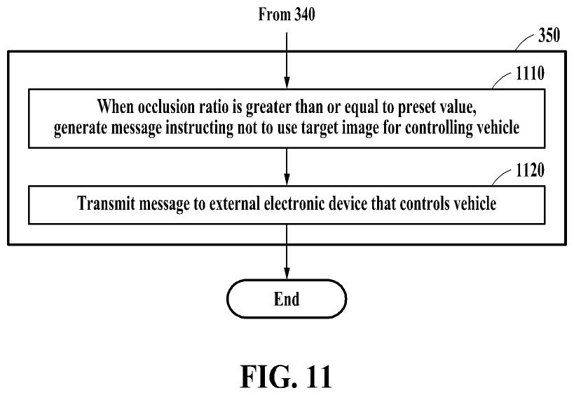

FIG. 11 is a flowchart of a method of controlling an electronic device based on an occlusion ratio according to an embodiment.

According to an embodiment, operations 1110 and 1120 may be performed after operation 340 described above with reference to FIG. 3. For example, operation 350 described above with reference to FIG. 3 may include operations 1110 and 1120. According to an embodiment, operations 1110 and 1120 may be performed by the electronic device 200 described above with reference to FIG. 2.

In operation 1110, when an occlusion ratio with respect to a target image is greater than or equal to a preset value, the electronic device 200 may generate a message instructing not to use a target image for controlling a vehicle. For example, the message may include a control signal to instruct that the target image is not used for a control operation, such as setting a driving path of the vehicle, determining obstacle avoidance, and controlling lane keeping.

In operation 1120, the electronic device 200 may transmit the message to an external electronic device that controls the vehicle. For example, the message may be transmitted via a wired communication scheme (e.g., automotive Ethernet) or a wireless communication scheme (e.g., Wi-Fi or Bluetooth). For example, the message may be transmitted to the external electronic device in real time to allow the external electronic device to respond immediately.

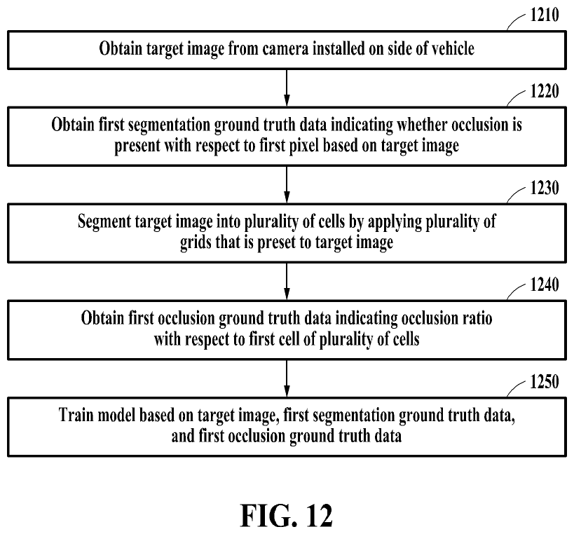

FIG. 12 is a flowchart of a method of learning an occlusion ratio with respect to a target image according to an embodiment.

According to an embodiment, operations 1210 to 1250 may be performed by the electronic device 200 described above with reference to FIG. 2.

In operation 1210, the electronic device 200 may obtain a target image from a camera installed on a side of the vehicle. The method of obtaining the target image may be replaced with the description of operation 310 provided above with reference to FIG. 3.

In operation 1220, the electronic device 200 may obtain first segmentation ground truth data indicating whether a first pixel is occluded based on the target image. For example, the first segmentation ground truth data may be collected from diagnostic information regarding the camera. For example, the first segmentation ground truth data may be collected by transforming a portion of a segmentation-based image dataset (e.g., Cityscapes dataset) for a contamination detection purpose into segmentation ground truth data having labels reconfigured to include contamination regions.

In operation 1230, the electronic device 200 may segment the target image into a plurality of cells by applying a plurality of grids that is preset to the target image. The method of segmenting the target image into the plurality of cells may be replaced with the description of operation 320 provided above with reference to FIG. 3.

In operation 1240, the electronic device 200 may obtain first occlusion ground truth data indicating an occlusion ratio with respect to a first cell of the plurality of cells. For example, the first occlusion ground truth data may be set as a mean of segmentation ground truth data pieces respectively corresponding to pixels included in the first cell.

In operation 1250, the electronic device 200 may train a model, based on the target image, the first segmentation ground truth data, and the first occlusion ground truth data. According to an embodiment, the electronic device 200 may be implemented as a single model that processes both the segmentation ground truth data and the occlusion ground truth data. For example, the model may include a first output unit that predicts whether the first pixel is occluded based on a first image, the first segmentation ground truth data, and the first occlusion ground truth data, and a second output unit that predicts an occlusion ratio with respect to a first grid region. According to an embodiment, the electronic device 200 may be implemented as a plurality of models for independently processing the segmentation ground truth data and the occlusion ground truth data. For example, the model may include a first network that is trained to predict whether the first pixel is occluded based on a first image and the first segmentation ground truth data, and a second network that is trained to predict the occlusion ratio with respect to the first grid region based on the first image and the first occlusion ground truth data.

The embodiments described herein may be implemented using a hardware component, a software component, and/or a combination thereof. For example, the device, the method, and the components described herein may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording media.

The methods according to the embodiments described herein may be recorded in non-transitory computer-readable media including program instructions to implement various operations of the embodiments. The media may also include the program instructions, data files, data structures, and the like alone or in combination. The program instructions recorded on the media may be those specially designed and constructed for the embodiments, or they may be of the kind well-known and available to those having skill in the computer software arts. Examples of non-transitory computer-readable media include magnetic media such as hard disks, floppy disks, and magnetic tape, optical media such as compact disc read-only memory (CD-ROM) discs and digital video discs (DVDs), magneto-optical media such as floptical disks, and hardware devices that are specifically configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The hardware devices described above may be configured to act as one or more software modules in order to perform the operations of the examples described above, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuitry are combined in a different manner, or replaced or supplemented by other components or their equivalents.

Therefore, other implementations, other embodiments, and/or equivalents of the claims are within the scope of the following claims.

What is claimed is:

1. A method performed by an electronic device, the method comprising:
obtaining a target image from a camera installed on a side of a vehicle;
segmenting the target image into a plurality of cells by applying a plurality of grids that is preset to the target image;
determining a first occlusion ratio with respect to a first cell of the plurality of cells using a first model that is pre-trained;
determining an occlusion ratio with respect to the target image based on the first occlusion ratio; and
controlling the electronic device based on the occlusion ratio.

2. The method of claim 1, wherein the determining of the occlusion ratio with respect to the target image based on the first occlusion ratio comprises determining the occlusion ratio, based on the first occlusion ratio and a second occlusion ratio with respect to a second cell of the plurality of cells.

3. The method of claim 2, wherein the determining of the occlusion ratio, based on the first occlusion ratio and the second occlusion ratio, comprises determining a mean of the first occlusion ratio and the second occlusion ratio to be the occlusion ratio.

4. The method of claim 1, further comprising:
determining severity of contamination with respect to the target image to be one of a plurality of grades based on the occlusion ratio.

5. The method of claim 1, further comprising:
determining an occlusion value with respect to each pixel of the target image using a second model that is pre-trained; and
determining a first corrected occlusion ratio, based on the first occlusion ratio and occlusion ratios with respect to first pixels comprised in the first cell.

6. The method of claim 1, further comprising:
determining a first block comprising one or more cells, wherein the first block comprises a first cell;
determining whether the first occlusion ratio is greater than or equal to a preset ratio; and
determining whether occlusion is present in the first block based on whether the first occlusion ratio is greater than or equal to the preset ratio.

7. The method of claim 6, further comprising:
when the occlusion is determined to be present in the first block, outputting position information about the first block.

8. The method of claim 2, wherein the determining of the occlusion ratio, based on the first occlusion ratio and the second occlusion ratio, comprises:
determining a first weight with respect to the first cell;
determining a first value, based on the first occlusion ratio and the first weight;
determining a second weight with respect to the second cell;
determining a second value, based on the second occlusion ratio and the second weight; and
determining the occlusion ratio, based on the first value and the second value.

9. The method of claim 1, wherein the controlling of the electronic device based on the occlusion ratio comprises, when the occlusion ratio is greater than or equal to a preset value, controlling the electronic device to output a notification.

10. The method of claim 1, wherein the controlling of the electronic device based on the occlusion ratio comprises:
when the occlusion ratio is greater than or equal to a preset value, generating a message instructing not to use the target image for controlling the vehicle; and
transmitting the message to an external electronic device that controls the vehicle.

11. A non-transitory computer-readable storage medium storing instructions that, when executed by a processor, cause the processor to perform the method of claim 1.

12. An electronic device comprising:
at least one processor comprising processing circuitry; and
memory comprising one or more storage media storing instructions,
wherein the instructions, when executed individually or collectively by the at least one processor, cause the electronic device to perform:
obtaining a target image from a camera installed on a side of a vehicle;
segmenting the target image into a plurality of cells by applying a plurality of grids that is preset to the target image;
determining a first occlusion ratio with respect to a first cell of the plurality of cells using a first model that is pre-trained;
determining an occlusion ratio with respect to the target image based on the first occlusion ratio; and
controlling the electronic device based on the occlusion ratio.

13. The electronic device of claim 12, wherein the determining of the occlusion ratio with respect to the target image based on the first occlusion ratio comprises determining the occlusion ratio, based on the first occlusion ratio and a second occlusion ratio with respect to a second cell of the plurality of cells.

14. The electronic device of claim 12, wherein the instructions, when executed individually or collectively by the at least one processor, cause the electronic device to further perform:
determining an occlusion value with respect to each pixel of the target image using a second model that is pre-trained; and
determining a first corrected occlusion ratio, based on the first occlusion ratio and occlusion ratios with respect to first pixels comprised in the first cell.

15. The electronic device of claim 12, wherein the instructions, when executed individually or collectively by the at least one processor, cause the electronic device to further perform:
determining a first block comprising one or more cells, wherein the first block comprises a first cell;
determining whether the first occlusion ratio is greater than or equal to a preset ratio; and
determining whether occlusion is present in the first block based on whether the first occlusion ratio is greater than or equal to the preset ratio.
